(19) United States
(12) Patent Application Publication
(10) Pub. No.: US 2007/0055438 A1
(43) Pub. Date: Mar. 8, 2007

(54) Method and apparatus for analysing particulates

(76) Inventor: Martyn Vincet Twigg, Cambridge (GB)

Correspondence Address: RATNERPRESTIA, P O BOX 980, VALLEY FORGE, PA, 19482-0980, US

(21) Appl. No.: 10/555,333

(22) PCT Filed: Apr. 27, 2004
(86) PCT No.: PCT/GB04/01832

§ 371 Date: Aug. 31, 2006

(30) Foreign Application Priority Data
Apr. 28, 2003 (GB) 0309604.7

(51) Int. Cl. G01N 27/26; G06F 17/00

(52) U.S. Cl. 701/109; 204/424

(57) ABSTRACT

A method of analysing a gas comprising solid particulates, hydrocarbons and acidic species comprises contacting a sample of the gas with a basic material (52) for absorbing the acidic species, analysing the inlet gas for particulates and analysing the gas leaving the basic material for particulates.

The present invention relates to a method and apparatus for analysing particulates, and in particular it relates to a method and apparatus for analysing particulates in a gas also comprising hydrocarbons and acidic species (e.g. sulfuric acid or nitric acid), such as an exhaust gas of an internal combustion engine.

Ambient particulate matter (PM) is divided by most authors into the following categories based on their aerodynamic diameter (the aerodynamic diameter is defined as the diameter of a 1 g/cm³ density sphere of the same settling velocity in air as the measured particle):

(i) PM-10—particles of an aerodynamic diameter of less than 10 μm;

(ii) Fine particles of diameters below 2.5 μm (PM-2.5),

(iii) Ultrafine particles of diameters below 0.1 μm or 100 nm; and

(iv) Nanoparticles, characterised by diameters of less than 50 mn.

Since the mid-1990's, particle size distributions of particulates exhausted from internal combustion engines have received increasing attention due to possible adverse health effects of fine and ultrafine particles. Concentrations of PM-10 particulates in ambient air are regulated by law in the USA. A new additional ambient air quality standard for PM-2.5 was introduced in the USA in 1997 as a result of health studies that indicated a strong correlation between human mortality and the concentration of fine particles below 2.5 μm

Interest has now shifted towards nanoparticles from diesel and gasoline because they are understood to penetrate more deeply into human lungs than particulates of greater size and consequently they are believed to be more harmful than larger particles, extrapolated from the findings of studies into particulates in the 2.5-10.0 μm range.

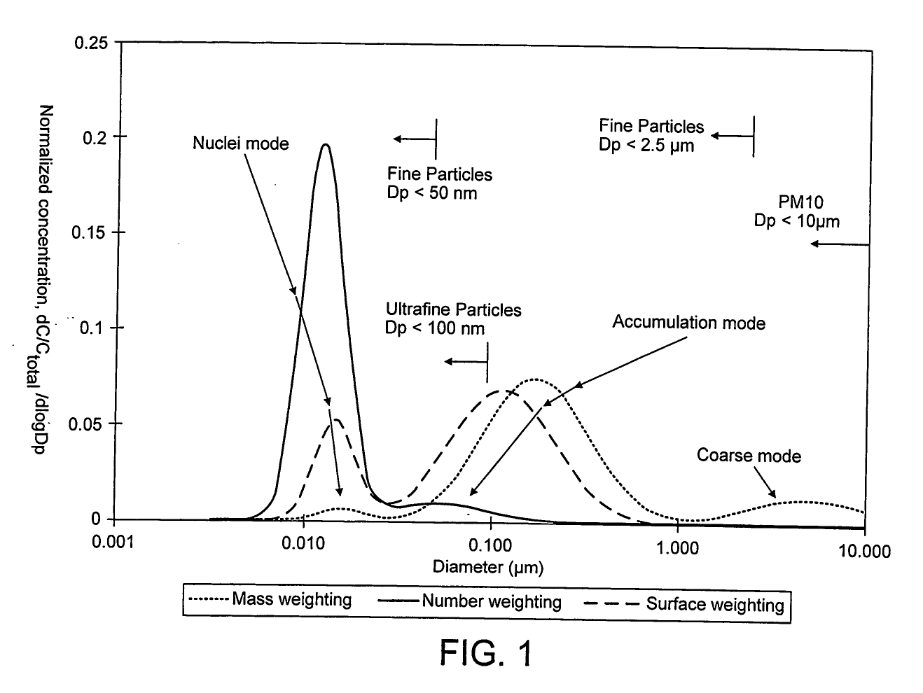

Size distributions of diesel particulates have a well-established bimodal character that corresponds to the particle nucleation and agglomeration mechanisms, with the corresponding particle types referred to as the nuclei mode and the accumulation mode respectively (see FIG. 1). As can be seen from FIG. 1, in the nuclei mode, diesel PM is composed of numerous small particles holding very little mass. Nearly all diesel particulates have sizes of significantly less than 1 μm, i.e. they comprise a mixture of fine, i.e. falling under the 1997 US law, ultrafine and nanoparticles.

Nuclei mode particles are believed to be composed mostly of volatile condensates (hydrocarbons, sulfuric acid, nitric acid etc) and contain little solid material, such as ash and carbon. Accumulation mode particles are understood to comprise solids (carbon, metallic ash etc.) intermixed with condensates and adsorbed material (heavy hydrocarbons, sulfur species, nitrogen oxide derivatives etc.). Coarse mode particles are not believed to be generated in the diesel combustion process and may be formed through mechanisms such as deposition and subsequent re-entrainment of particulate material from the walls of an engine cylinder, exhaust system, or the particulate sampling system. The relationship between these modes is shown in FIG. 1.

The composition of nucleating particles may change with engine operating conditions, environmental condition (particularly temperature and humidity), dilution and sampling system conditions. Laboratory work and theory have shown that most of the nuclei mode formation and growth occur in the low dilution ratio range. In this range, gas to particle conversion of volatile particle precursors, like heavy hydrocarbons and sulfuric acid, leads to simultaneous nucleation and growth of the nuclei mode and adsorption onto existing particles in the accumulation mode. Laboratory tests (see e.g. SAE 980525 and 2001-01-0201) have shown that nuclei mode formation increases strongly with decreasing air dilution temperature but there is conflicting evidence on whether humidity has an influence.

Generally, low temperature, low dilution ratios, high humidity and long residence times favour nanoparticles formation and growth. Studies have shown that nanoparticles consist mainly of volatile material like heavy hydrocarbons and sulfuric acid with evidence of solid fraction only at very high loads.

Due to current PM sampling techniques, diesel PM can include both solids, such as elemental carbon and ash, and liquids, such as condensed hydrocarbons, water, and acidic species derived from other exhaust gas components such as from nitrogen oxides, e.g. nitric acid (nitrates), or those from sulfur oxides, such as sulfuric acid. However, there is no available medical research to indicate what risk condensates, such as hydrocarbons and acidic species, represent to human health. In order to probe this issue it is desirable to distinguish between solid nanoparticles and condensate nanoparticles.

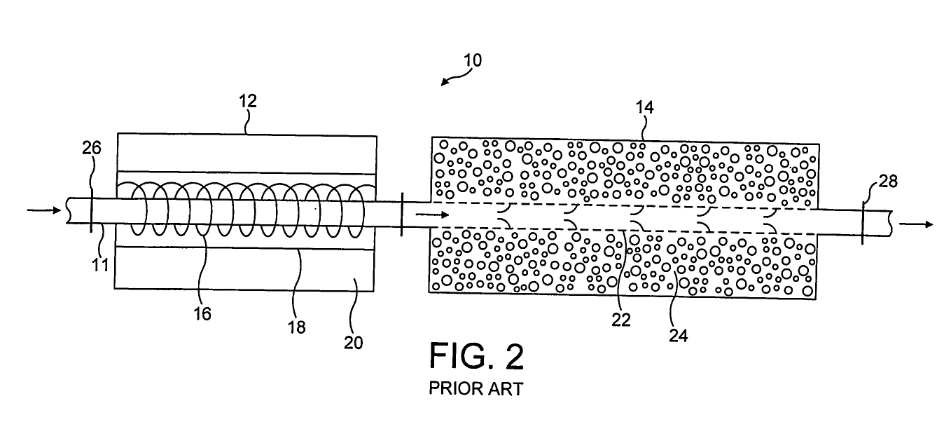

One prior art method used to distinguish between solid and condensate nanoparticles in an exhaust gas includes passing a sample through a device called a “thermal denuder”. The typical arrangement of such a thermal denuder is illustrated in FIG. 2 and consists of two parts: a heating part for combusting a volatile fraction in the gas; and a charcoal part for absorbing (by molecular diffusion) evaporated material including non-combusted volatiles, and other condensates, such as sulfuric acid droplets. By subtracting the amount of solid particulates detected downstream of the thermal denuder from the total amount of particulates detected upstream of the device it is possible to determine the number of condensate particulates in a sample.

A problem with the thermal denuder is that it cannot remove all condensates. Accordingly, analysis of solid particulates downstream can produce variable results because samples include unknown quantities of condensates. There are a number of reasons for this including: (i) inefficient absorption; (ii) the charcoal part needs to be regenerated or replaced relatively frequently because it becomes saturated with hydrocarbon condensates; (iii) it is difficult to determine when the useful life of the charcoal has been exceeded; and (iv) absorbed condensates can be desorbed and passed downstream.

An alternative to the thermal denuder is to use a heated catalytic converter as described in SAE 982599 (called a “catalytic stripper system” or “CSS” in that paper) to compare amounts of particles detected in “stripped” and untreated diluted exhaust gas streams. However, no details of the catalytic converter are given and we believe that, whilst the catalytic converter may remove some or all of the volatile hydrocarbon fraction, it may actually contribute to the amount of acidic particulates detected as it can oxidise e.g. SO₂ to SO₃, which combines with water vapour in the gas to form droplets of sulfuric acid.

We have now developed an alternative to the prior art methods that avoids or reduces problems associated therewith. Moreover, in certain embodiments our methods can provide a greater degree of flexibility and insight to the researcher by providing improved particulate speciation e.g. between acidic sulfate- and nitrate-derived particulates, particulates derived from volatile components such as hydrocarbons and solid carbon.

According to one aspect, the invention provides a method of analysing a gas comprising solid particulates, hydrocarbons and acidic species, which method comprising the steps of contacting a sample of the gas with a basic material for absorbing the acidic species, analysing the inlet gas for particulates and analysing the gas sample leaving the basic material for particulates.

The Chambers Dictionary of Science and Technology (W & R Chambers Ltd 1971) defines “absorption” as the penetration of a substance into the body of another; and “adsorption” as the taking up of one substance at the surface of another. For the avoidance of doubt, we intend adsorption and absorption to be used interchangeably herein, and absorb, adsorb, etc should be interpreted accordingly.

The invention provides a number of very useful advantages over the prior art By use of the invention, it is possible reliably to remove the acidic species component of a gas for the purposes of analysis. This is because the acidic species are removed by chemical reaction with the basic material, so there is no significant vapour pressure. This contrasts with the thermal denuder, as discussed above, and the catalytic stripper system, which actually contributes to the number of particulates in the gas rather than removing them, e.g. because it oxidises SO₂ to SO₃ which combines with water in the gas and is detected as droplets of sulfuric acid.

Another advantage is that the capacity of the basic material is unlikely to become exhausted during its useful life, (although it can be regenerated by known techniques, e.g. a high temperature reducing atmosphere, if required).

In particular embodiments, the method according to the invention comprises at least one additional step selected from:

i) contacting the gas sample with a catalyst for oxidising the hydrocarbons and analysing the gas sample leaving the oxidation catalyst for particulates;

ii) contacting the gas sample with a catalyst for selectively oxidising the hydrocarbons relative to oxidising SO₂ to SO₃, which catalyst is selected from the group consisting of palladium, rhodium, gold, and mixtures of any two or more thereof, and analysing the gas sample leaving the selective oxidation catalyst for particulates;

iii) contacting the gas sample with an oxidation catalyst for oxidising the hydrocarbons and a basic material for absorbing the acidic species and analysing the outlet gas sample for particulates; and

iv) contacting the gas sample with a particulate filter for removing solid particulates and analysing the gas sample leaving the filter for particulates.

By comparing the results obtained by passing the untreated gas over each component, it is possible for a researcher to determine what fraction of the PM-10, PM-2.5, ultrafines and nanoparticles are acidic species, hydrocarbons and solid particulates (depending on what additional steps are used) in combination.

In another embodiment, step i) is inserted between the steps of analysing the inlet gas for particulates and contacting the gas sample with the basic material. That is, the gas sample is analysed both upstream and downstream of the oxidation catalyst, and the gas sample leaving the oxidation catalyst is passed over the basic material, following which it is analysed again.

“Acidic species” as defined herein include nitrogen oxide- and sulfur oxide-derived particulates or particulate precursors including sulfur dioxide, sulfur trioxide, nitrogen monoxide, nitrogen dioxide, nitric acid and sulfuric acid.

In one embodiment, the basic material of step iii) coexists with the oxidation catalyst. However, in a particular embodiment, at least some of the oxidation catalyst is disposed upstream of the basic material. This is because the oxidation catalyst can oxidise sulfur dioxide (SO₂) in the exhaust gas to sulfur trioxide (SO₃). SO₃ can combine with H₂O in the gas to generate sulfuric acid (H₂SO₄) droplets, which may be detected as particulates. Hence, it is desirable to position the acidic sulfate absorber downstream of the oxidation catalyst to absorb any H₂SO₄ generated over the oxidation catalyst so that, according to the embodiment, the H₂SO₄ does not interfere with any intended detection of only solid particulate in the gas.

The particulate filter can be any filter capable of removing PM down to a chosen grade of fineness, and pore sizes can be chosen accordingly. It will be understood that in order selectively to remove solid particles from the gas sample and enable downstream analysis to detect non-solid particles or non-solid particles and solid particles of a particular grade of fineness (as selected by the porosity of the filter), the filter should be maintained at a sufficiently high temperature for heavy hydrocarbons to remain in the vapour phase, e.g. >300° C. This can be effected by providing an electrically heated element upstream of the filter, or by integrating the element into the filter material itself. Typically the filter is a ceramic wall-flow filter, but metal filters can also be used; of course, metal filters are more easily heated.

Various methods can be used to manipulate the data obtained from each analysis. For example, in one embodiment, an analysed value of the particulates from the analysis of the untreated gas is compared with the corresponding value from the or each downstream analysis. (The “value” analysed can be any desired detectable parameter, such as the mass of the particulate in the gas, the number of particulates in the gas and/or the surface area of the particulate in the gas. Any of these values can be measured as a function of particle size (see FIG. 1) using suitable instrumentation.)

In another embodiment, a net value for the analysed value corresponding to a component removed from the untreated gas is obtained by subtracting the value obtained from the or each downstream analysis from the corresponding value from the analysis of the untreated gas. For example, the method can provide a value for acidic species and hydrocarbon particulates by analysing the total particulates in the untreated gas and subtracting the analysed value for the value of particulates detected in the gas leaving the combined acidic species absorber and oxidation catalyst.

Methods of analysing particulates in a gas can include a step of diluting the gas e.g. in order to simulate atmospheric dilution and this may be done in one or more series of dilutions. Where a dilution step is utilised in the method of the present invention, in one embodiment it is diluted prior to contacting the basic material.

In one embodiment, the gas is an exhaust gas of an internal combustion engine, such as a gasoline or a diesel engine.

In a particular embodiment, the analysis step of the method according to the invention comprises measuring solid particles, e.g. solid nanoparticles, in the gas.

The analytical means can comprise any suitable analytical instrument, e.g. a differential mobility analyser, a scanning mobility particle sizer or a condensation particle counter, or other suitable technique.

According to another aspect, the invention provides an apparatus for analysing a gas comprising solid particulates, hydrocarbons and acidic species, which apparatus comprising a first component comprising a basic material for absorbing the acidic species, means for analysing the inlet gas for particulates and means for analysing the first component outlet gas for particulates.

Typically, the basic material for use in the invention is a compound of an element known to absorb acidic species such as nitrogen oxides and sulfur oxides and their derivatives. These include compounds of alkali metals, such as potassium and caesium, compounds of alkaline earth metal, e.g. barium, strontium, calcium or magnesium, or compounds of rare earth metals e.g. lanthanum or yttrium. Alternatively, mixtures of any two or more of these compounds can be used, e.g. a mixture of barium and caesium. Generally, the compounds (prior to absorption of acidic sulfur- and nitrogen-containing components) will be one or more oxides of the elements described, but they may also be present as the hydroxides or carbonates.

In one embodiment, the apparatus for use in the invention comprises a second component disposed downstream of the means for analysing the inlet gas, which second component comprising a basic material for absorbing acidic species (as described above) and an oxidation catalyst for oxidising hydrocarbons and means for analysing the second component outlet gas for particulates.

In another embodiment, the apparatus comprises a third component disposed downstream of the means for analysing the inlet gas, which third component comprising a particulate filter for removing solid particulates and means for analysing the third component outlet gas for particulates.

According to a further embodiment, the apparatus comprises a fourth embodiment disposed downstream of the means for analysing the inlet gas, which fourth component comprising an oxidation catalyst for oxidising the hydrocarbons and means for analysing the fourth component outlet gas for particulates.

The oxidation catalyst for use with the second and fourth components typically comprises platinum, or at least one transition metal, e.g. manganese, nickel, iron or cobalt. Alternatively, a mixture of any two or more PGMs and/or transition metals can be used, e.g. a mixture of platinum and manganese, a mixture of iron and cobalt or a mixture of platinum and palladium. Such oxidation catalysts generally promote the oxidation of hydrocarbons to carbon dioxide and water, but can also promote oxidation of acidic species such as nitrogen monoxide (NO) to nitrogen dioxide (NO₂) and sulfur dioxide (SO₂) to sulfur trioxide (SO₃). For this reason, a particular arrangement of the second component is for at least some of the oxidation catalyst to be disposed upstream of the basic material, so that acidic species such as NO₂ and SO₃ can be absorbed on it. In another arrangement, the oxidation catalyst and the basic material co-exist.

In one preferred embodiment, the oxidation catalyst comprises platinum supported on alumina.

In another embodiment, the apparatus comprises a fifth component disposed downstream of the means for analysing the inlet gas, which fifth component comprising an oxidation catalyst for oxidising the hydrocarbons relative to oxidising SO₂ to SO₃, which catalyst is selected from the group consisting of palladium, rhodium, gold, and mixtures of any two or more thereof, and means for analysing the fifth component outlet gas for particulates. This embodiment provides a further tool for the skilled engineer to select the particulates for analysis in the outlet gas.

Ordinarily, the oxidation catalyst and the basic material comprise at least one support selected from alumina, titania, silica, ceria, zirconia, amorphous silica-alumina, and zeolites, and mixtures, mixed oxides and composite oxides of any two or more thereof. By “composite oxide” herein, we mean a largely amorphous oxide material comprising oxides of at least two elements which are not true mixed oxides consisting of the at least two elements.

In order to optimise the activity of each component of the apparatus, variables that can be adjusted include the length of the catalytic/absorber sections, the channel dimensions, and the characteristics (e.g. surface area).

The support material can be selected to minimise adsorption of species it is not intended to oxidise by or absorb on the catalyst or basic material respectively, thereby improving the accuracy of the analysis downstream. Such selection can be for lower porosity supports to prevent e.g. hydrocarbons adsorbing to basic materials. Such supports can include lower surface area phases of alumina e.g. alpha, theta or delta instead of gamma

Generally, the oxidation catalyst and/or the basic material are supported on a monolithic substrate, such as a metal or ceramic material. In one embodiment, the oxidation catalyst and the basic material of the second component are supported on a single monolithic substrate, each in a separate zone. Alternatively, where the oxidation catalyst and the basic material co-exist, they can be supported in different layers or on the same support material on a monolithic substrate.

The basic material and/or the oxidation catalyst can include means to heat the basic material and/or oxidation catalyst to a desired temperature for optimal activity. Suitable heating means can include an external power source comprising a battery or a mains transformer, or the temperature of the incoming gas may be sufficient to heat the component to a desired temperature. Where electrical heating is used, in a particular embodiment, the monolithic substrate includes a suitable element and connection terminals. In a further embodiment, the apparatus of the invention comprises means, such as a thermocouple, for detecting the temperature of the supported material to ensure optimum apparatus temperature.

Suitable operating temperatures for a typical acidic species absorber e.g. BaO supported on alumina is 350-500° C., such as 400-450° C. A platinum on alumina oxidation catalyst e.g. at 75 g ft⁻³ loading can be active for oxidising volatile hydrocarbons at from about 300° C. and above, e.g. at up to 500° C., such as from 350-450° C.

Typically, the or each monolithic substrate will be disposed in a reactor can or housing for insertion in a line for receiving a flowing gas sample for detection by a suitable analysis means.

In order that the invention may be more fully understood, an embodiment will now be described with reference to the accompanying drawings, in which:

FIG. 1 is a plot of normalised particulate concentration in a diesel exhaust gas sample as a function of particulate diameter;

FIG. 2 is a schematic of a prior art thermal denuder device;

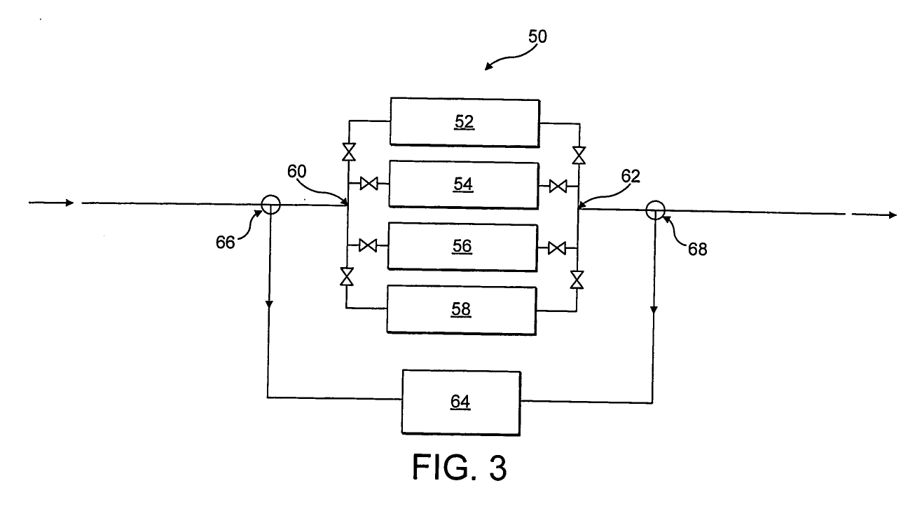

FIG. 3 is a schematic of an analytical instrument according to the present invention;

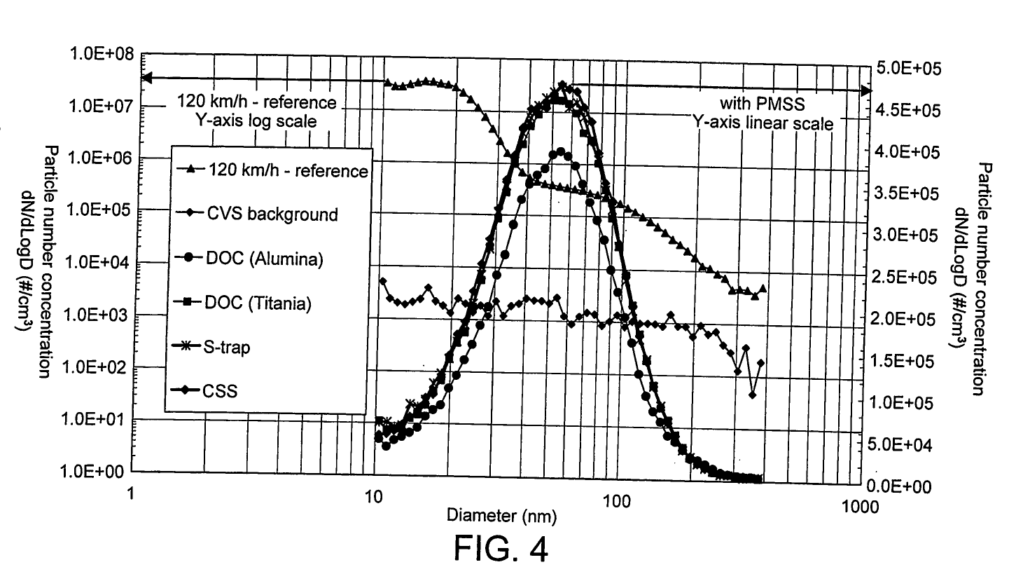

FIG. 4 is a graph showing the effect of apparatus components on particle number and size emissions for a 2.5 litre Diesel vehicle fitted with a catalysed soot filter at 120 km/h using fuel containing 350 ppm sulfur;

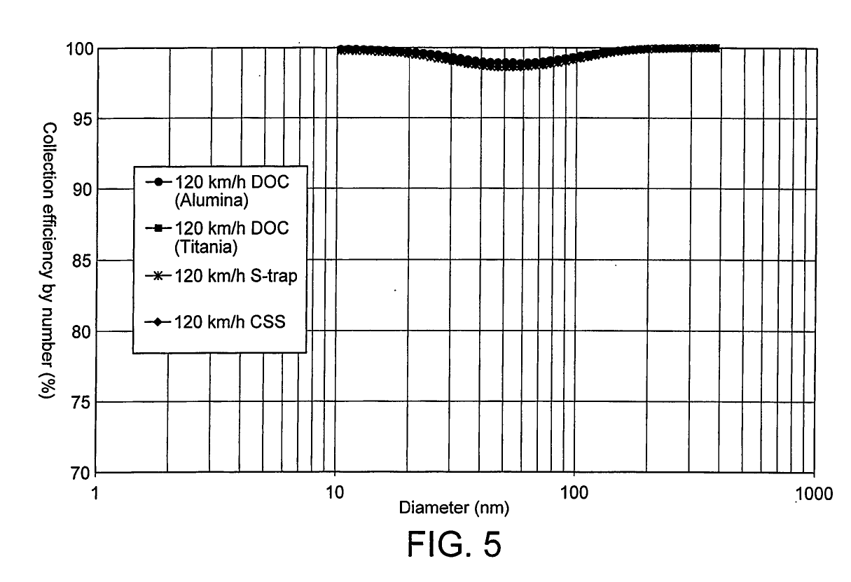

FIG. 5 is a graph showing the collection efficiency by number (%) vs. particle size for the results shown in FIG. 4;

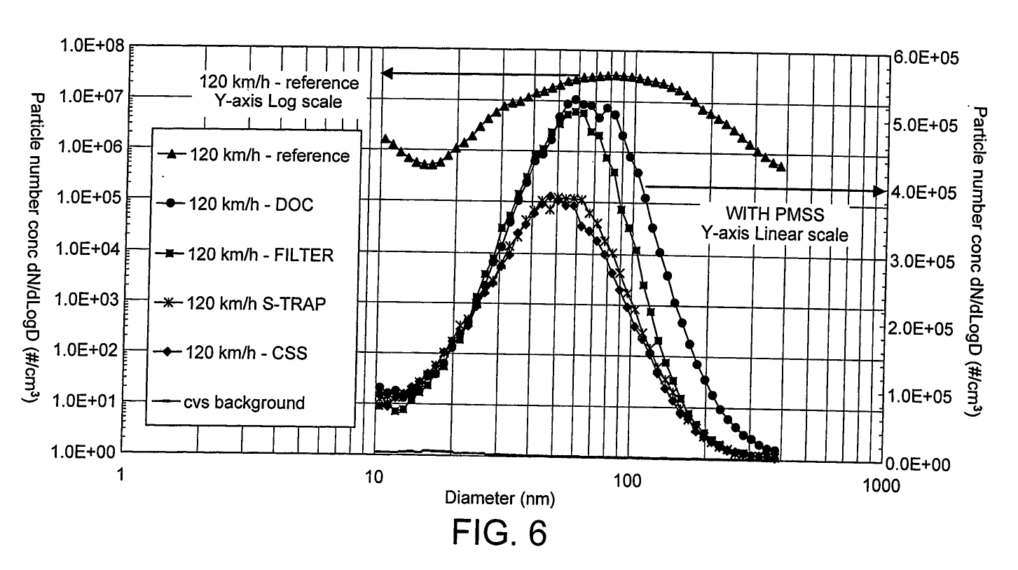

FIG. 6 is a graph showing the effect of apparatus components on particle number and size emissions from the 2.5 litre TDi Diesel vehicle of FIG. 4 at 120 km/h using fuel containing 350 ppm sulfur wherein the CSF is exchanged in the exhaust system for a bare filter substrate;

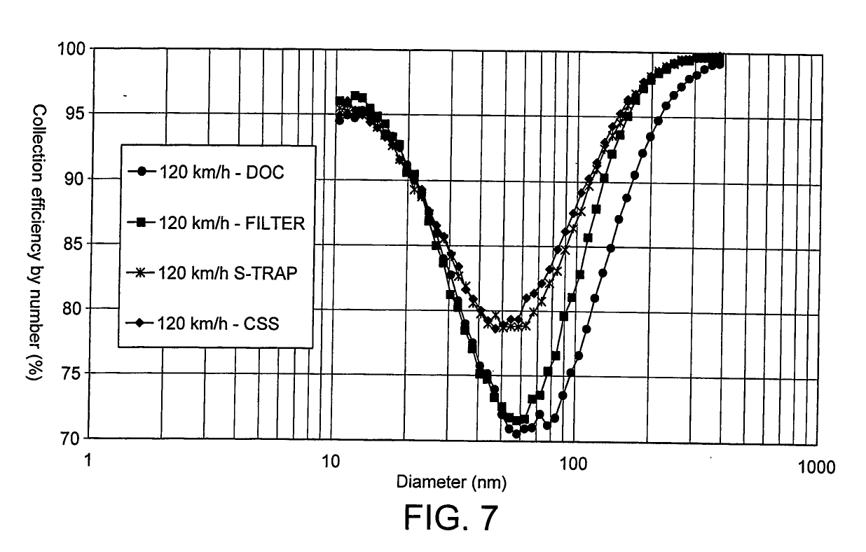

FIG. 7 is a graph showing the collection efficiency by number (%) vs. particle size for the results shown in FIG. 6;

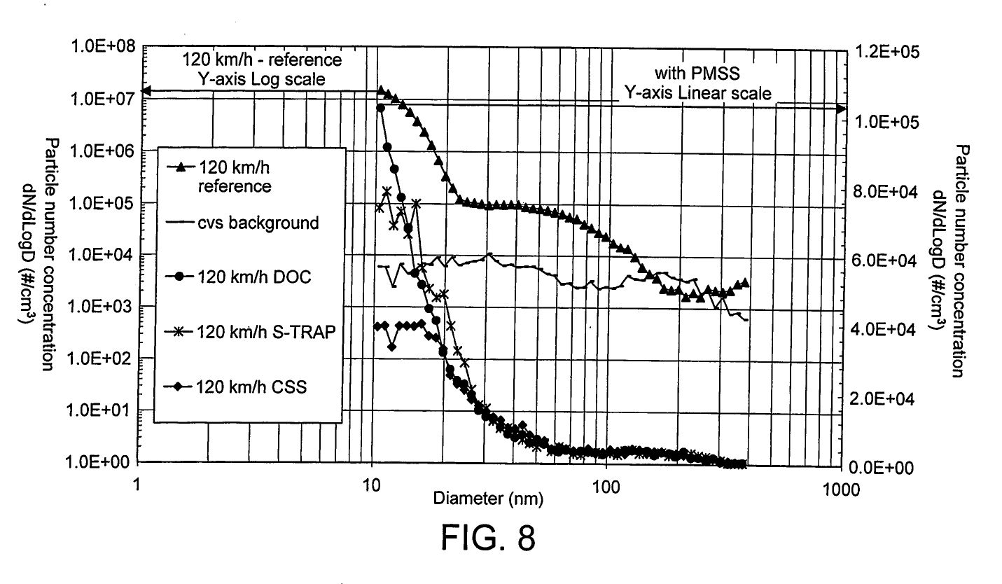

FIG. 8 is a graph showing typical particle size distribution and number concentration measurements at 120 km/h for a 1.9 litre TDi Diesel vehicle fitted with a catalysed soot filter and run on 4 ppm sulfur fuel (log scale); and

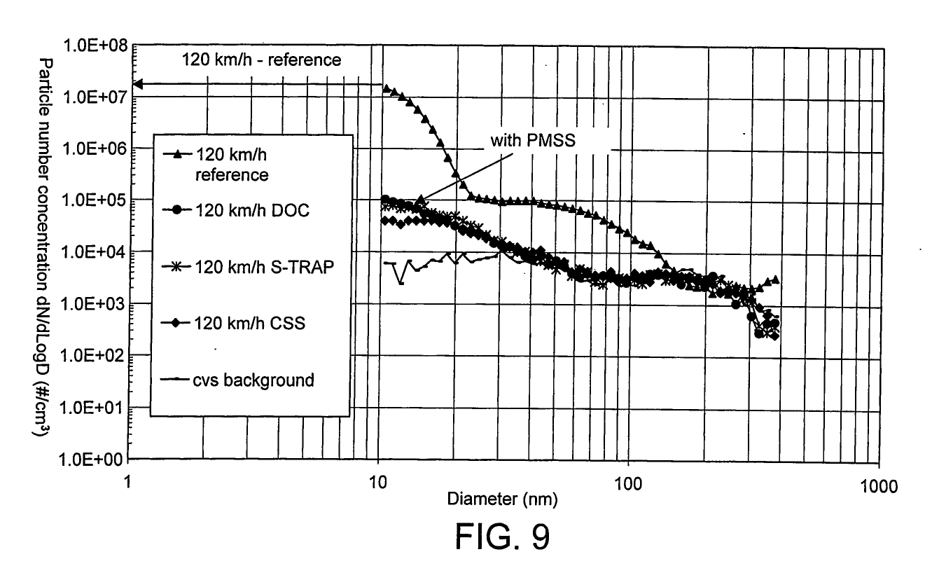

FIG. 9 is another representation of the results shown in FIG. 8, but with the results from using the apparatus of the invention plotted on a linear scale.

Referring to the schematic shown in FIG. 2, the prior art thermal denuder 10 comprises a stainless steel conduit 11 of 20 mm diameter disposed within two reactor cans 12, 14 arranged in series. Reactor can 12 comprises a heating section including an electric heating coil 16, surrounded by fine sand 18 and insulation material 20. Reactor can 14 comprises a cooling section including a stainless steel gauze. The space defined by the gauze and the internal surface of the can 14 is filled with activated charcoal 24. Each can 12, 14 is approximately 500 mm in length.

Thermal denuder 10 is arranged so that a gas flows in the direction from the heating section to the cooling section via inlet 26 and outlet 28. Gas may be sampled using suitable analytical instruments (not shown) upstream and downstream of thermal denuder 10, or a single gas sampling port may be located downstream of outlet 28 and a thermal denuder bypass installed in order to compare treated and untreated gas samples.

Referring to FIG. 3, there is shown a schematic diagram of an embodiment of an apparatus 50 according to the present invention, wherein: 52 is a reactor can comprising a 400 cells per square inch (cpsi) (62 cells cm⁻²) flow-through ceramic monolithic substrate coated with a washcoat of barium oxide (500 g ft⁻³) supported on particulate alumina for absorbing acidic species in a gas; 54 is a reactor can comprising a 400 (62 cells cm⁻²) cpsi flow-through ceramic monolithic substrate coated with an oxidation catalyst composition comprising platinum (75 g ft⁻³) on particulate alumina; 56 is a reactor can comprising a 400 cpsi (62 cells cm⁻²) flow-through ceramic monolith substrate coated with a washcoat comprising particulate alumina supporting barium oxide and platinum, i.e. a combined oxidation catalyst and acidic species absorber; and 58 is a reactor can comprising 400 cpsi (62 cells cm⁻²) ceramic wall-flow filter for trapping particulates of diameter >2.5 μm from the exhaust gas.

Each component 52, 54, 56, 58 is connected to a gas supply inlet 60 and outlet 62 using stainless steel tubing. Gas supply inlet 60 receives a gas supply e.g. a diluted gas for sampling from suitable gas handling means (not shown).

The stainless steel tubing connecting each component 52, 54, 56, 58 includes gas tight valves so that each component 52, 54, 56 58 may be isolated from the gas supply.

Analyser 64 e.g. a differential mobility analyser or a scanning mobility particle sizer, receives an untreated gas sample from upstream of components 52, 54, 56, 58 via sample port 66.

The valve arrangement in apparatus 50 can be switched so that gas flows from inlet 60 to outlet 62 via component 52, 54, 56 or 58 as desired and a gas sample is extracted downstream at sampling port 68 for transfer to analyser 64. Accordingly, a comparison can be made between particulate detected in untreated gas and gas treated with component 53, 54, 56 or 58.

An alternative arrangement uses a single gas sampling port 68 and a bypass loop for bypassing all of components 52, 54, 56, 58 with the gas sample for analysis of untreated gas and then components 52, 54, 56, 58 can be switched in as desired in order to provide a comparison with the analysed bypassed sample.

An illustration of the speciation that is possible in an apparatus according to the present invention using the first through fifth components is provided in Table 1. The diluted diesel exhaust gas sample at the inlet to each component contains solid particulate (PM), a soluble organic fraction of hydrocarbons (SOF) and sulfur dioxide (SO₂).

TABLE 1

| | | Expected particulate | | |
|---|---|---|---|---|
| | Illustrative | components in outlet gas | | |
| Component | Composition | PM | SOF | SO₃ |
| First | BaO/Al₂O₃ | Yes | Yes | No |
| Second | Pt/BaO/Al₂O₃ | Yes | No | No |
| Third | Cordierite | No¹ | Yes | Yes |
| | particulate filter | | | |
| Fourth | Pt/Al₂O₃ | Yes | No | Yes |
| Fifth | Pd/Al₂O₃ | Yes | No² | No³ |

¹Depending on the porosity of the filter.
²Pd is not as active for SOF oxidation as Pt and so some HC species may slip the catalyst.
³Pd is selective for SOF oxidation relative to SO₂ oxidation at temperatures of up to about 250° C. (see WO 99/36162).

It can be seen, for example, that an apparatus comprising the first, third and fourth components can yield details of the following particulates content in the gas sample: solid particulates (by comparison of the inlet gas analysis with analysis of the outlet gas sample from the third component), SOF (by analysing the inlet gas and comparing it with an analysis of the fourth component outlet gas) and SO₂ (by difference between the analysis of outlet gas samples from the third and fourth components combined with that of the outlet gas sample of the first component).

The following Example is provided by way of illustration only.

### EXAMPLE

An investigation of the nature of the nuclei mode particles in the exhaust stream of a light-duty diesel vehicle was undertaken using an apparatus illustrated in FIG. 3. The system, identified as Particulate Matter Speciation System (PMSS), includes, as separate components, the following commercially available elements: a diesel oxidation catalyst ((DOC) Pt on alumina) and sulfur trap in combination; a DOC (two different formulations were tested: a platinum catalyst supported on particulate alumina; and a platinum catalyst supported on particulate titania); a sulfur trap per se; and a commercially available diesel particulate filter. Each catalyst or trap formulation was coated on a separate flow-through monolith (34 mm OD×110 mm length) and all four components were inserted in a metal can with heating tapes comprising an electrically heated element affixed. In the case of the combined DOC and sulfur trap, the two components were disposed with the DOC segment upstream of the sulfur trap. Each can was heated to a desired temperature to evaporate volatile compounds (T>300° C.)

An exhaust gas sample was first diluted using a standard Constant Volume Sampling (CVS) dilution system and then passed through each PMSS component at a flow rate to allow sufficient residence time to heat the sample to the required temperature, to efficiently evaporate the volatile material and to promote catalytic conversion. The outlet gas samples were cooled in a copper coil and then passed into the particle measurement instruments. Particle size and number were measured using a Scanning Mobility Particle Sizer (SMPS).

Vehicle testing was conducted on a TDi 2.5 litre Diesel vehicle and a TDi 1.9 litre Diesel vehicle fitted with the same commercially available catalysed soot filter. Tests were done using both low sulfur (<4 ppm) and high sulfur (350 ppm) fuels because higher sulfur levels can favour nucleation. Both vehicles used sulfur-containing lube oil, which may also contribute to nucleation. Steady-state engine conditions at speeds representative of the Euro III drive cycle (idle, 30, 50, 70, 120 km/h) were chosen with particular attention to high-speed conditions as these are reported to favour particle nucleation.

Results obtained from tests conducted at 120 km/h are shown in FIGS. 4 to 9 in which SMPS measurements are reported in terms of particle concentration by number versus particle size (electrical mobility diameter) at a vehicle speed of 120 km/h for the 2.5 litre vehicle (FIGS. 4 and 5) and for the 1.9 litre TDi vehicle (FIGS. 8 and 9). Further testing to compare the speciation of the PMSS is shown in FIGS. 6 and 7, wherein the CSF of the 2.5 litre vehicle was exchanged for a bare filter substrate. Measurements of the untreated exhaust (no PMSS), indicated as 120 km/h reference, are shown on the left-hand axis in the log-scale while measurements with each PMSS component are shown in the right-hand axis on a linear scale in all except FIG. 8 to better highlight differences in size distribution as well as number emission concentrations. Measurement of the CVS background prior to each test is also reported.

It can be seen from FIG. 4 that the PMSS reduces the nuclei mode peak by around three orders of magnitude for particle sizes 10-20 nm and by two orders of magnitude for 30 nm particles, with a distribution shifted towards bigger particle sizes, peaking at around 60 nm. In particular, it can be seen that the alumina-based DOC reduces the particulates detected more than the titania-based DOC and the other PMSS components and we believe that this is because it is a superior oxidation catalyst for volatile hydrocarbons. Further investigations are being made as to why a similar reduction was not seen with the combined alumina-based DOC and sulfur-trap, but it can be seen that the combined DOC and sulfur-trap and the sulfur-trap per se perform similarly to one another. The collection efficiency by number is above 98% for all particle sizes measured and almost 100% for 10-20 nm (FIG. 5).

Referring to the comparison test results shown in FIG. 6, the untreated exhaust particle size distribution is characterized by an agglomeration mode peaking at around 80-100 nm with values of the order of 10⁷ #/cm³. Wit the PMSS, particle number emissions are reduced by two orders of magnitude in the accumulation mode with the DOC (Pt on alumina) and filter and even greater reductions are observed when using the combined DOC and sulfur-trap and sulfur-trap per se. In addition, nanoparticles (10-30 nm) are reduced by over one order of magnitude when using the PMSS components. Collection efficiency by number vs. particle size is shown in FIG. 7; values are around 95% at 10-15 nm for all components of the PMSS, about 80% at 50-60 nm with the combined DOC and sulfur-tap and sulfur-trap per se and 70% at 50-60 nm for the DOC and filter. With the combined DOC and sulfur-trap and sulfur-trap per se, the collection efficiency was from 90-100% for particle sizes from 100-300 nm.

The results shown in FIGS. 8 and 9 show that in the nuclei mode, substantial reductions are again observed when using the PMSS system; number emissions are reduced by over two orders of magnitude with the DOC (Pt on alumina) and even more when using the combined DOC and sulfur-trap, at 10 nm. Significantly, reductions are also seen in the accumulation mode (one order of magnitude) when using the PMSS components. Whilst it would be expected to see some difference between the particle size distributions observed in the untreated exhaust gas between the two vehicles because of the difference in fuel sulfur content, it is suggested that the sulfur in the lube oil may contribute to the results.

The results presented show that the PMSS instrument according to the present invention is capable of speciating between exhaust gas particles found in an exhaust gas of a Diesel engine. In particular, a nucleation mode in the particle size distribution for the untreated exhaust stream was consistently observed at 120 km/h in all tests on both vehicles. High numbers of nanoparticles of the order of 10⁷ (#/cm³) were measured with the SMPS, with a particle size distribution peaking around 10-20 nm as shown in FIGS. 4 and 8. Tests in which the CSF is exchanged for a bare substrate showed a shift in the particle size distribution towards bigger particle sizes in the range (80-100 μm) (see FIG. 6).

The PMSS was particularly effective in reducing nanoparticle emissions when passing the diluted exhaust through each component. In particular, it was possible to observe differences in the shape of the size distribution as well as number concentration when using one component of the PMSS at a time.

1. A method of analysing a gas comprising solid particulates, hydrocarbons and acidic species, which method comprising the steps of contacting a sample of the gas with a basic material for absorbing the acidic species, the basic material selected from the group consisting of a compound of an alkali metal, a compound of an alkaline earth metal, a compound of a rare earth metal and mixtures of any two or more thereof; analysing the inlet gas for particulates; and analysing the gas samples leaving the basic material for particulates.

2. A method according to claim 1, wherein the temperature of the basic material is at from 350-500° C.

3. A method according to claim 1, further comprising at least one additional step selected from the group consisting of:
(i) contacting the gas sample with a catalyst for oxidising the hydrocarbons and analysing the gas sample leaving the oxidation catalyst for particulates;
(ii) contacting the gas sample with a catalyst for selectively oxidising the hydrocarbons relative to oxidising SO₂ to SO₃, which catalyst is selected from the group consisting of palladium, rhodium, gold, and mixtures of any two or more thereof, and analysing the gas sample leaving the selective oxidation catalyst for particulates;
(iii) contacting the gas sample with an oxidation catalyst for oxidising the hydrocarbons and a basic material for absorbing the acidic species and analysing the outlet gas sample for particulates; and
(iv) contacting the gas sample with a particulate filter for removing solid particulates and analysing the gas sample leaving the filter for particulates.

4. A method according to claim 3, wherein the at least one additional step is step i), wherein step i) is performed between the steps of analysing the inlet gas for particulates and contacting the gas sample with the basic material.

5. A method according to claim 3, wherein the at least one additional step is step iii) and in step iii) the untreated gas sample contacts the oxidation catalyst before contacting the basic material.

6. A method according to claim 3, wherein the at least one additional step is step iii) and in step iii) the gas sample contacts the oxidation catalyst and the basic material simultaneously.

7. A method according to claim 3, further comprising the step of comparing an analysed value of the particulates from the analysis of the sample with the corresponding value from the or each downstream analysis.

8. A method according to claim 7, further comprising the step of obtaining a net value for the analysed value corresponding to a component removed from the untreated gas by subtracting the value obtained from the or each downstream analysis from the corresponding value from the analysis of the sample.

9.-13. (canceled)

14. A method according to claim 1, wherein the sample is a dilution of the gas to be analysed.

15. A method according to claim 1, wherein the gas is an exhaust gas of an a diesel engine.

16. (canceled)

17. A method according to claim 1, wherein the acidic species is selected from the group consisting of sulfur dioxide, sulfur trioxide, nitrogen monoxide, nitrogen dioxide, sulfuric acid and nitric acid.

18. An apparatus for analysing a gas comprising solid particulates, hydrocarbons and acidic species, which apparatus comprising a first component comprising a basic material for absorbing the acidic species, said basic material is selected from the group consisting of a compound of an alkali metal, a compound of an alkaline earth metal, a compound of a rare earth metal and mixtures of any two or more thereof; means for analysing the inlet gas for particulates; and means for analysing the first component outlet gas for particulates.

19. (canceled)

20. An apparatus according to claim 18, further comprising a second component disposed downstream of the means for analysing the inlet gas, which second component comprising a basic material for absorbing the acidic species and an oxidation catalyst for oxidising hydrocarbons and means for analysing the second component outlet gas for particulates.

21. (canceled)

22. (canceled)

23. An apparatus according to claim 20, further comprising a third component disposed downstream of the means for analysing the inlet gas, which third component comprising a particulate filter for removing solid particulates and means for analysing the third component outlet gas for particulates.

24. An apparatus according to claim 23, further comprising a fourth component disposed downstream of the means for analysing the inlet gas, which fourth component comprising an oxidation catalyst for oxidising the hydrocarbons and means for analysing the fourth component outlet gas for particulates.

25. An apparatus according to claim 24, wherein the fourth component outlet gas is fed to the inlet of the first component downstream of the means for analysing the inlet gas.

26. An apparatus according to claim 24, further comprising a fifth component disposed downstream of the means for analysing the inlet gas, which fifth component comprising an oxidation catalyst for oxidising the hydrocarbons relative to oxidising SO₂ to SO₃, which catalyst is selected from the group consisting of palladium, rhodium, gold, and mixtures of any two or more thereof, and means for analysing the fifth component outlet gas for particulates.

27. An apparatus according to claim 18, wherein the or each analysis means measures a parameter selected from the group consisting of: the mass value of the particulate in the gas, the number value of particulate in the gas, and the surface area value of the particulate in the gas.

28. (canceled)

29. (canceled)

30. An apparatus according to any claim 27, wherein the analysis means measures the value as a function of particle size.

31. An apparatus according to claim 18, wherein the analysis means measures nanoparticles in the gas.

32. An apparatus according to claim 18, wherein the analysis means is selected from the group consisting of: a differential mobility analyser, a scanning mobility particle sizer, and a condensation particle counter.

33.-37. (canceled)

38. An apparatus according to claim 20, wherein the basic material and/or the oxidation catalyst is supported on a monolithic substrate.

39.-42. (canceled)

43. The method of claim 2 wherein the temperature of the basic material is 400-450° C.
